(19) United States
(12) Patent Application Publication
(10) Pub. No.: US 2024/0304015 A1
(43) Pub. Date: Sep. 12, 2024

(54) METHOD OF TRAINING DEEP LEARNING MODEL FOR TEXT DETECTION AND TEXT DETECTION METHOD

(71) Applicant: Beijing Baidu Netcom Science Technology Co., Ltd., Beijing (CN)

(72) Inventors: Sen FAN, Beijing (CN); Xiaoyan WANG, Beijing (CN); Pengyuan LV, Beijing (CN); Chengquan ZHANG, Beijing (CN); Kun YAO, Beijing (CN)

(73) Assignee: Beijing Baidu Netcom Science Technology Co., Ltd., Beijing (CN)

(21) Appl. No.: 18/041,265

(22) PCT Filed: Apr. 21, 2022
(86) PCT No.: PCT/CN2022/088280

§ 371 Date: Feb. 10, 2023

(30) Foreign Application Priority Data
Aug. 13, 2021 (CN) 202110932789.4

(51) Int. Cl. G06V 30/19; G06V 30/148; G06V 30/18

(52) U.S. Cl. CPC G06V 30/19167; G06V 30/153; G06V 30/18; G06V 30/19147; G06V 30/1916

(57) ABSTRACT

The present disclosure provides a method of training a deep learning model for text detection and a text detection method, which relates to the technical field of artificial intelligence, and in particular, to the technical field of computer vision and deep learning and can be used in scenarios of OCR optical character recognition. A method of training a deep learning model for text detection is provided, in which a single character segmentation sub-network outputs a single character segmentation prediction result, a text line segmentation sub-network outputs a text line segmentation prediction result, the trained deep learning model can be used for detecting a text area; and, can at the same time achieve single character segmentation and text line segmentation, and thus is capable to perform text detection by combining two ways of text segmentation, which further improves the accuracy of text area detection.

The present application claims the priority to a Chinese patent application No. 202110932789.4 filed with the China National Intellectual Property Administration on Aug. 13, 2021 and entitled “Method of Training a Deep Learning Model for Text Detection and Text Detection Method”, which is incorporated herein by reference in its entirety.

### TECHNICAL FIELD

The present disclosure relates to the technical field of artificial intelligence, and in particular, to the technical field of computer vision and deep learning, and specifically, relates to a method of training a deep learning model for text detection, as well as a text detection method, apparatus, device, and storage medium.

### BACKGROUND

As the deep learning technology develops, text detection based on a deep learning model has been widely applied in industries and academia, for example, real-time tourism translation, the digitalization of paper documents, sign board recognition, photo and text review, etc. In order to achieve the detection of a text in an image, the area of the text in the image needs to be determined first.

### SUMMARY

The present disclosure provides a method of training a deep learning model for text detection, as well as a text detection method, apparatus, device, and storage medium.

According to a first aspect of the present disclosure, a method of training a deep learning model for text detection is provided. The method comprises: obtaining a deep learning model to be trained, wherein, the deep learning model comprises a single character prediction network and a text line prediction network, the single character prediction network comprises a single character segmentation sub-network and a first character number prediction sub-network, the text line prediction network comprises a text line segmentation sub-network and a second character number prediction sub-network; selecting a piece of first-type sample data and tag data of the currently selected first-type sample data; inputting the currently selected first-type sample data into the deep learning model, to obtain a prediction result of the currently selected first-type sample data, wherein, the prediction result comprises a single character segmentation prediction result, a first character number prediction value, a text line segmentation prediction result, and a second character number prediction value; adjusting training parameters of the deep learning model based on the prediction result and the tag data of the currently selected first-type sample data, to obtain a trained deep learning model.

According to a second aspect of the present disclosure, a text detection method is provided, comprising: obtaining data to be detected; inputting the data to be detected into a pre-trained deep learning model, to obtain a single character segmentation prediction result and a text line segmentation prediction result of the data to be detected, wherein, the deep learning model is obtained based on the method of training a deep learning model for text detection described in the present disclosure; determining a text area in the data to be detected based on the single character segmentation prediction result and the text line segmentation prediction result of the data to be detected.

According to a third aspect of the present disclosure, an apparatus of training a deep learning model for text detection is provided. The apparatus comprises: a deep learning model obtaining module configured for obtaining a deep learning model to be trained, wherein, the deep learning model comprises a single character prediction network and a text line prediction network, the single character prediction network comprises a single character segmentation sub-network and a first character number prediction sub-network, the text line prediction network comprises a text line segmentation sub-network and a second character number prediction sub-network; a first-type sample data selecting module configured for selecting a piece of first-type sample data and tag data of the currently selected first-type sample data; a prediction result determining module configured for inputting the currently selected first-type sample data into the deep learning model, to obtain a prediction result of the currently selected first-type sample data, wherein, the prediction result comprises a single character segmentation prediction result, a first character number prediction value, a text line segmentation prediction result, and a second character number prediction value; a training parameter adjusting module configured for adjusting training parameters of the deep learning model based on the prediction result and the tag data of the currently selected first-type sample data, to obtain a trained deep learning model.

According to a fourth aspect of the present disclosure, a text detection apparatus is provided, comprising: a to-be-detected data obtaining module configured for obtaining data to be detected; a prediction result determining module configured for inputting the data to be detected into a pre-trained deep learning model, to obtain a single character segmentation prediction result and a text line segmentation prediction result of the data to be detected, wherein, the deep learning model is obtained based on the apparatus of training a deep learning model for text detection described in the present application; a text area determining module configured for determining a text area in the data to be detected based on the single character segmentation prediction result and the text line segmentation prediction result of the data to be detected.

According to a fifth aspect of the present disclosure, an electronic device is provided, comprising: at least one processor; and a memory communicatively coupled with the at least one processor; wherein, the memory has stored thereon instructions capable of being executed by the at least one processor, the instructions are executed by the at least processor to enable the at least one processor to execute the method described in the present application.

According to a sixth aspect of the present disclosure, a non-transitory computer-readable storage medium having stored thereon computer instructions is provided, wherein the computer instructions are configured to enable the computer to execute any method of training a deep learning model for text detection or text detection method described in the present application.

According to a seventh aspect of the present disclosure, a computer program product including a computer program is provided, the computer program, when executed by a processor, causes the processor to execute any method of training a deep learning model for text detection or text detection method described in the present application.

In the embodiments of the present disclosure, a method of training a deep learning model for text detection is provided. The trained deep learning model can be used for detecting a text area; and, can at the same time achieve single character segmentation and text line segmentation, and thus is capable to perform text detection by combining two ways of text segmentation, which further improves the accuracy of text area detection.

It should be understood that what is described in this section is not intended to identify key or important features of the embodiments of the present disclosure, nor is it intended to limit the scope of the present disclosure. Other features of the present disclosure will be readily understood through the following description.

### BRIEF DESCRIPTION OF DRAWINGS

In order to illustrate the technical solutions of the embodiments of the present invention and of the prior art more clearly, the accompanying drawings that need to be used in the embodiments and the prior art are briefly introduced below. Obviously, the accompanying drawings in the following description are only for some of the embodiments of the present invention, those skilled in the art can also obtain other drawings based on these drawings without creative efforts.

FIG. 1 is a schematic view of a method of training a deep learning model for text detection according to an embodiment of the present disclosure;

FIG. 2 is a schematic view of a possible implementation of step S13 in an embodiment of the present disclosure;

FIG. 3 is a schematic view of the process of supervised training according to an embodiment of the present disclosure;

FIG. 4 is a schematic view of the process of unsupervised training according to an embodiment of the present disclosure;

FIG. 5 is a schematic view of a text detection method according to an embodiment of the present disclosure;

FIG. 6 is a schematic view of a possible implementation of step S53 in an embodiment of the present disclosure;

FIG. 7 is a schematic view of an apparatus of training a deep learning model for text detection according to an embodiment of the present disclosure;

FIG. 8 is a block diagram of an electronic device for implementing the method of an embodiment of the present disclosure.

### DETAILED DESCRIPTION OF EMBODIMENTS

In order to make the object, technical solution, and advantages of the present invention clearer, the present invention will be further described in detail below with reference to the accompanying drawings and examples. Apparently, the described embodiments are only some of the embodiments of the present invention, but not all of them. Based on the embodiments of the present invention, all other embodiments obtained by those of ordinary skill in the art without creative efforts fall within the protection scope of the present invention.

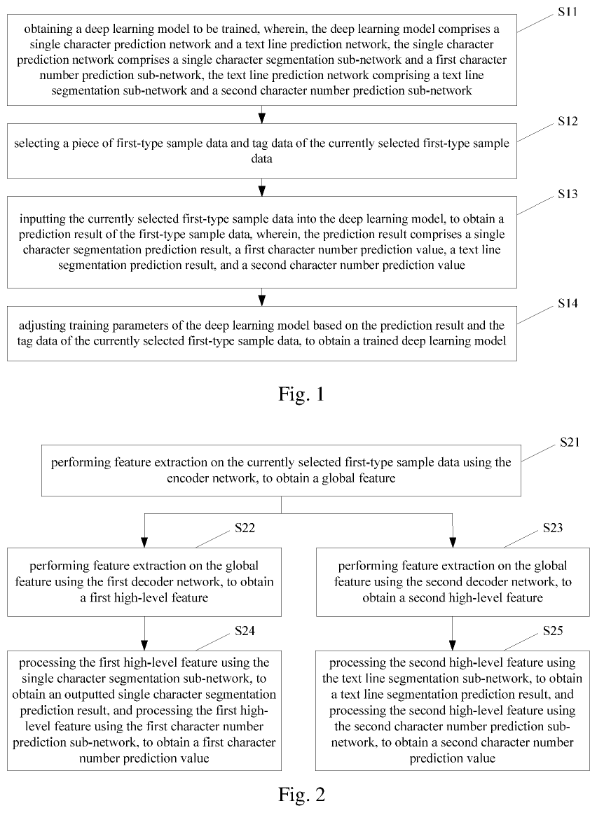

In order to achieve detection of a text in an image, the area of the text in the image needs to be determined first. In view of this, an embodiment of the present disclosure provides a method of training a deep learning model for text detection. With reference to FIG. 1, the method comprises:

S11, obtaining a deep learning model to be trained, wherein, the deep learning model comprises a single character prediction network and a text line prediction network, the single character prediction network comprises a single character segmentation sub-network and a first character number prediction sub-network, the text line prediction network comprising a text line segmentation sub-network and a second character number prediction sub-network.

The method of training a deep learning model for text detection in an embodiment of the present disclosure can be implemented by an electronic device. Specifically, the electronic device can be a smart phone, a personal computer, a server, etc.

The deep learning model to be trained comprises a single character prediction network and a text line prediction network, wherein the single character prediction network comprising a single character segmentation sub-network and a first character number prediction sub-network, the text line prediction network comprising a text line segmentation sub-network and a second character number prediction sub-network. The single character segmentation sub-network is used for predicting a result of single character segmentation. i.e., predicting the area of each single character in an image; the text line segmentation sub-network is used for predicting a result of text line segmentation, i.e., predicting the area of each text line in an image. The first character number prediction sub-network and the second character number prediction sub-network are both used for predicting the value of the character number, i.e., predicting how many characters are in the image.

The specific network structures of the single character segmentation sub-network, the first character number prediction sub-network, the text line segmentation sub-network, and the second character number prediction sub-network can be customized based on the actual situation. In an example, the single character segmentation sub-network can comprise multiple convolutional layers and can also comprise a classifier; the first character number prediction sub-network can comprise multiple convolutional layers and a fully connected layer; the text line segmentation sub-network can comprise multiple convolutional layers and can also comprise a classifier; the second character number prediction sub-network can comprise multiple convolutional layers and a fully connected layer.

S12, selecting a piece of first-type sample data and tag data of the currently selected first-type sample data.

In an example, first-type sample data that has not been selected can be selected from a sample set containing multiple pieces of first-type sample data, as the currently selected first-type sample data. The first-type sample data can be an image. The first-type sample data has tag data comprising at least one of a character number true value, a single character segmentation true value result, and a text line segmentation true value result of the first-type sample data. The tag data of the first-type sample data can be obtained by manual tagging and the like.

S13, inputting the currently selected first-type sample data into the deep learning model, to obtain a prediction result of the first-type sample data, wherein, the prediction result comprises a single character segmentation prediction result, a first character number prediction value, a text line segmentation prediction result, and a second character number prediction value.

With the currently selected first-type sample data being inputted into the deep learning model, in the deep learning model, the single character segmentation sub-network outputs a corresponding single character segmentation prediction result, the first character number prediction sub-network outputs a corresponding first character number prediction result, the text line segmentation sub-network outputs a corresponding text line segmentation prediction result, and the second character number prediction sub-network outputs a corresponding second character number prediction value. In an example, each sub-network in the deep learning model can have a separate corresponding feature extraction network. The first-type sample data are first inputted into each feature extraction network, and, after feature extraction, inputted into the corresponding sub-networks. In an example, each sub-network can share a feature extraction network. In an example, some of the sub-networks can share a feature extraction network, and some of the sub-networks can have separate corresponding feature extraction networks. All those are within the scope of protection of the present application.

S14, adjusting training parameters of the deep learning model based on the prediction result and the tag data of the currently selected first-type sample data, to obtain a trained deep learning model.

In an example, the loss of each network can be calculated respectively based on the prediction results of the first-type sample data and the true values in the tag data, and training parameters of the network can be adjusted based on the loss of the network, thus achieving the adjustment of the training parameters of the deep learning model.

For example, a first loss is calculated based on the single character segmentation prediction result and the single character segmentation true value result of the currently selected first-type sample data, and training parameters of the single character segmentation sub-network are adjusted based on the first loss. For example, a second loss is calculated based on the first character number prediction value and character number true value of the currently selected first-type sample data, and training parameters of the first character number prediction sub-network are adjusted based on the second loss. For example, a third loss is calculated based on the text line segmentation prediction result and the text line segmentation true value result of the currently selected first-type sample data, and training parameters of the text line segmentation sub-network are adjusted based on the third loss. For example, a fourth loss is calculated based on the second character number prediction value and character number true value of the currently selected first-type sample data, and training parameters of the second character number prediction sub-network are adjusted based on the fourth loss.

One can refer to training parameter adjustment methods in the prior art for how to adjust training parameters based on a loss. In an example, training parameters of a network can be adjusted based on a loss in accordance with the SGD (Stochastic Gradient Descent) algorithm.

After the deep learning model has been trained once, first-type sample data continues to be selected to train the deep learning model, until a preset training completion condition is satisfied, so that a trained deep learning model is obtained. The preset training completion condition can be customized based on the actual situation and can be, for example, loss convergence of the deep learning model, reaching a predicted number of times of training, etc. When the preset training completion condition is satisfied, training is stopped, and a trained deep learning model is obtained.

In an embodiment of the present disclosure, a method of training a deep learning model for text detection is provided. The trained deep learning model can be used for text area detection, and can at the same time achieve single character segmentation and text line segmentation, and thus is capable to perform text detection by combining two ways of text segmentation, which further improves the accuracy of text area detection.

In a possible implementation, the deep learning model further comprises an encoder network, a first decoder network, and a second decoder network. With reference to FIG. 2, inputting the currently selected first-type sample data into the deep learning model, to obtain a prediction result of the currently selected first-type sample data, comprises:

S21, performing feature extraction on the currently selected first-type sample data using the encoder network, to obtain a global feature.

In an example, the encoder network can use a lightweight Mobile-v3 network in combination with a Unet network to perform global feature extraction on inputted image data, to obtain a global feature.

S22, performing feature extraction on the global feature using the first decoder network, to obtain a first high-level feature.

In an example, the first decoder network can comprise a multi-layer fully convolutional network used for performing further feature extraction on the global feature from the encoder network, the image feature obtained being referred to as a first high-level feature. Wherein, the high-level feature is an image feature with rich semantic information but rough target location.

S23, performing feature extraction on the global feature using the second decoder network, to obtain a second high-level feature.

In an example, the second decoder network can comprise a multi-layer fully convolutional network used for performing further high-level feature extraction on the global feature from the encoder network.

S24, processing the first high-level feature using the single character segmentation sub-network, to obtain an outputted single character segmentation prediction result, and processing the first high-level feature using the first character number prediction sub-network, to obtain a first character number prediction value;

In an example, the first high-level feature outputted by the first decoder network passes through the plurality of convolutional layers in the single character segmentation sub-network to obtain a feature map of single character foreground and background classification, and then passes through a convolutional layer of a filter in the single character segmentation sub-network to obtain a single output map used for representing the segmentation of foreground and background, obtaining a single character segmentation prediction result wherein the foreground is 1 and the background is 0. The first high-level feature outputted by the first decoder network passes through a plurality of convolutional layers in the first character number prediction sub-network for further feature extraction, and then passes through a fully connected layer of the first character number prediction sub-network to perform prediction by using a word number prediction task as a classification task, to obtain a first character number prediction value. In an example, the output result of the fully connected layer can be 1000 categories respectively corresponding to the character number of 0 to 999.

S25, processing the second high-level feature using the text line segmentation sub-network, to obtain a text line segmentation prediction result, and processing the second high-level feature using the second character number prediction sub-network, to obtain a second character number prediction value.

In an example, the second high-level feature outputted by the second decoder network passes through the plurality of convolutional layers in the text line segmentation sub-network to obtain a feature map of text line foreground and background classification, and then passes through a convolutional layer of a filter in the text line segmentation sub-network to obtain a single output map used for representing the segmentation of foreground and background, obtaining a text line segmentation prediction result wherein the foreground is 1 and the background is 0. The second high-level feature outputted by the second decoder network passes through a plurality of convolutional layers in the second character number prediction sub-network for further feature extraction, and then passes through a fully connected layer of the second character number prediction sub-network to perform prediction by using a word number prediction task as a classification task, to obtain a second character number prediction value. In an example, the output result of the fully connected layer can be 1000 categories respectively corresponding to the character number of 0 to 999.

In an embodiment of the present disclosure, the first high-level feature extracted by the first decoder network is used for the prediction of the single character prediction network, and the second high-level feature extracted by the second decoder network is used for the prediction of the text line prediction network. Training parameters of the first decoder network and training parameters of the second decoder network can be adjusted respectively to achieve the decoupling of input data of the single character prediction network and the text line prediction network, which can increase recognition accuracy of the single character prediction network and the text line prediction network and thus ultimately increase the prediction accuracy of text area detection and character number prediction.

In a possible implementation, the tag data of the first-type sample data comprises at least one of a character number true value, a single character segmentation true value result, and a text line segmentation true value result. The step of adjusting training parameters of the deep learning model based on the prediction result and the tag data of the currently selected first-type sample data, comprises at least one of the following steps:

Step 1, calculating a first loss based on the single character segmentation prediction result of the currently selected first-type sample data and the single character segmentation true value result of the currently selected first-type sample data; adjusting training parameters of at least one of the encoder network, the first decoder network, and the single character segmentation sub-network based on the first loss.

Step 2, calculating a second loss based on the first character number prediction value of the currently selected first-type sample data and the character number true value of the currently selected first-type sample data; adjusting training parameters of at least one of the encoder network, the first decoder network, and the first character number prediction sub-network based on the second loss.

Step 3, calculating a third loss based on the text line segmentation prediction result of the currently selected first-type sample data and the text line segmentation true value result of the currently selected first-type sample data; adjusting training parameters of at least one of the encoder network, the second decoder network, and the text line segmentation sub-network based on the third loss.

Step 4, calculating a fourth loss based on the second character number prediction value of the currently selected first-type sample data and the character number true value of the currently selected first-type sample data; adjusting training parameters of at least one of the encoder network, the second decoder network, and the second character number prediction sub-network based on the fourth loss.

In an example, the first loss and the third loss can be a cross-entropy loss, for example, a binary cross-entropy loss. In an example, the character number prediction value can be used as a category. For example, 1000 categories respectively corresponding to character number of 0 to 999 can be provided. In this case, it can also be provided that each of the second loss and the fourth loss area is a cross-entropy loss.

In an embodiment of the present disclosure, a method of adjusting training parameters of various networks is provided, wherein a plurality of losses are used to adjust training parameters of various networks, which can improve the prediction accuracy of various networks.

In a possible implementation, the method further comprises:
Step A, determining relative entropies of the first character number prediction values and the second character number prediction values of multiple pieces of first-type sample data based on the first character number prediction values and the second character number prediction values, to obtain first relative entropies;
Step B, adjusting training parameters of at least one of the first character number prediction sub-network and the second character number prediction sub-network based on the first relative entropies.

In an embodiment of the present disclosure, it is designed that DML (Deep Mutual Learning) is performed using the first character number prediction sub-network and the second character number prediction sub-network, whether the predictions of the two sub-networks match is evaluated by means of KL divergence (Kullback-Leibler Divergence) and then training is performed with the aim of constraining the degree of match between these two. Because the training of an input feature of the first character number prediction sub-network involves single character location supervision information, the single character number can be predicted more accurately. By mutual learning of two character number prediction sub-networks, the prediction result of the second character number prediction sub-network and the prediction result of the first character number prediction sub-network can be rendered as consistent as possible, so that the second character number prediction sub-network learns the knowledge of the first character number prediction sub-network. In addition, as the first character number prediction sub-network and the second character number prediction sub-network are trained from different initial conditions and have different input features, even though they share the same tag, they may have different estimates for the probability of the next most likely category. Information learned by deep mutual learning provides additional knowledge for training and thus can further increase the prediction accuracy of the deep learning module, i.e., the accuracy of text line detection.

In a possible implementation, the obtaining of the trained deep learning model comprises:
continuing to select first-type sample data to perform supervised training on the deep learning model, and perform unsupervised training on the deep learning model using second-type sample data, until a preset training completion condition is satisfied, so that a trained deep learning model is obtained.

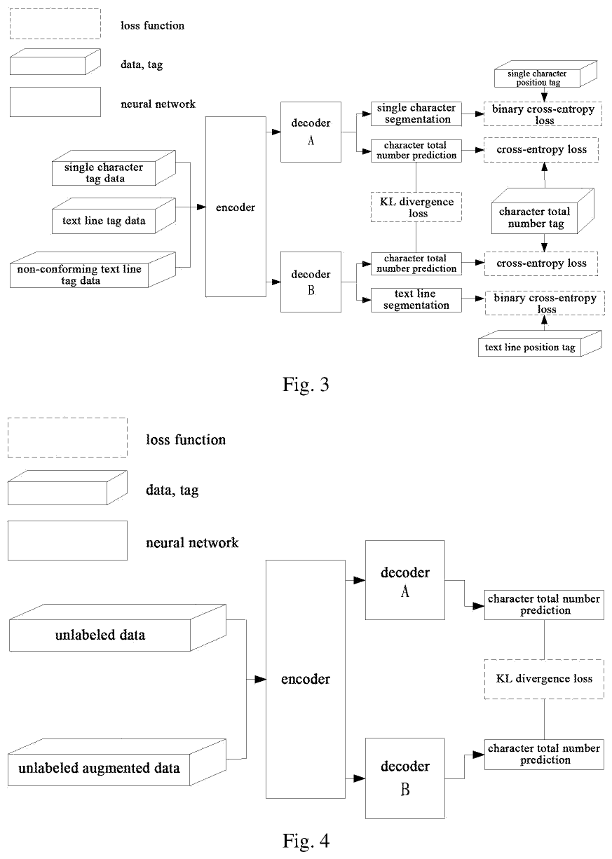

Supervised training is the process of training the deep learning model using the first-type sample data in the above-described embodiment. In an example, the process of supervised training can be as shown in FIG. 3. Each batch of sample data is composed of 3 parts. For example, the width of the sample data of a batch can be (3*B, 3, 512, 512) representing 3*B RGB (an image format) images of 512 in width×512 in height. The first B images can be labeled with a single character tag data value (comprising a character number true value and a single character segmentation true value), the middle B images are labeled with a text line tag data value (comprising a character number true value and a text line segmentation true value result), and the last B images are non-conforming text line tag data. Here, the 3*B is a hyperparameter of model training and is generally determined based on computing resources. When the sample data of a batch flows through an encoder (encoder network), a corresponding global feature is obtained. Then, the global feature passes through both DecoderA (i.e. the first decoder network) and DecoderB (i.e. the second decoder network), obtaining corresponding features FA (the first high-level feature) and FB (the second high-level feature). Feature FA then passes through the single character prediction network for single character segmentation and character total number prediction, thus obtaining a single character segmentation prediction result and a first character number prediction value. Feature FB passes through the text line prediction network for text line segmentation and character total number prediction, thus obtaining a text line segmentation prediction result and a second character number prediction value. In this example, cross-entropy represents cross-entropy loss, Binary cross-entropy represents binary cross-entropy loss, and KL-loss represents KL divergence loss, and label represents a label.

When a first training condition is satisfied in the event of supervised training of the deep learning model, unsupervised training is added to carry out at the same time as the supervised training. In an example, the process of supervised training can be as shown in FIG. 4. By constraining that prediction stays the same before and after augmentation of unlabeled sample data, model overfitting issues are remedied. In relevant text detection technology, as character number prediction is not involved, common methods of data augmentation include cropping. However, in an embodiment of the present disclosure, character number prediction is required. Therefore, in an embodiment of the present disclosure, methods of data augmentation that do not change the number of characters, such as blurring, rotating, flipping, and styling, are used.

In the stage of unsupervised training, the sample data of each batch is composed of two parts. Assume that the dimensions of the sample data of a batch is (2*N, 3, 512, 512), representing 2*N RGB images of 512 in width×512 in height, wherein, the first N images are any sample images and the last N images are augmented data corresponding to the first N images. The augmentation method includes any one of blurring, rotating, flipping, and styling. After the sample data of each batch passes through the encoder network, a global feature corresponding to unlabeled data (corresponding to second sample data) is inputted into the decoder A, and then passes through the first character number prediction sub-network, obtaining a character number prediction value (corresponding to third character number prediction value) of non-augmented sample data. A global feature corresponding to unlabeled augmented data (corresponding to third sample data) is inputted into the decoder B, and then passes through the second character number prediction sub-network, obtaining a character number prediction value (corresponding to fourth character number prediction value) of augmented sample data. Consistent learning of the first character number prediction sub-network and the second character number prediction sub-network is performed using KL divergence based on the third character number prediction value and the fourth character number prediction value. In this example, the process of unsupervised training does not train the single character segmentation sub-network or the text line segmentation sub-network. In this example, KL-loss represents KL divergence loss.

The first training condition can be set based on the actual situation and can be, for example, the number of times of training reaching a preset first number of times of training, or the degree of convergence of the deep learning model reaching a first degree of convergence. The preset training completion condition can be set based on the actual situation and can be, for example, the number of times of training reaching a second number of times of training, or the degree of convergence of the deep learning model reaching a second degree of convergence. In this example, the preset first number of times of training is smaller than the preset second number of times of training, and the convergence range of the first degree of convergence is larger than that of the second degree of convergence.

The process of unsupervised training is described below as an example. In a possible implementation, performing unsupervised training on the deep learning model using second-type sample data comprises:
Step A, obtaining multiple pieces of second-type sample data;
Step B, performing data augmentation on the respective pieces of second-type sample data, to obtain respective pieces of third-type sample data corresponding to the respective pieces of second-type sample data;
Step C, inputting the respective pieces of second-type sample data into the trained deep learning model, to obtain third character number prediction values of the respective pieces of second-type sample data outputted by the first character number prediction sub-network;
Step D, inputting the respective pieces of third-type sample data into the trained deep learning model, to obtain fourth character number prediction values of the respective pieces of third-type sample data outputted by the second character number prediction sub-network;
Step E, determining relative entropies of the third character number prediction values of the respective pieces of second-type sample data and the fourth character number prediction values of the respective pieces of third-type sample data based on the third character number prediction values and the fourth character number prediction values, to obtain second relative entropies;
Step F, adjusting training parameters of at least one of the first character number prediction sub-network and the second character number prediction sub-network according to the second relative entropies.

In an embodiment of the present disclosure, the deep learning model is trained by using both supervised training and unsupervised training, and different learning tasks are combined for different data, with a simple training logic. During the process of unsupervised training, a massive amount of unlabeled sample data can be fully used for consistency learning, which can reduce model overfitting. In addition, by using unlabeled sample data to train a model, workload of labeling sample data can be reduced while ensuring the final text detection precision, which can be applicable to scenarios of relatively few labeled data.

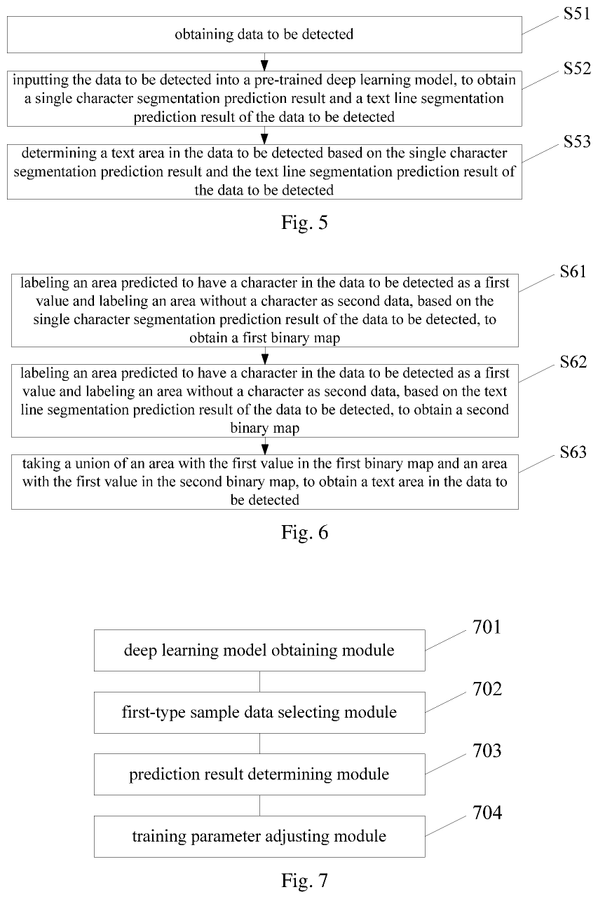

With reference to FIG. 5, an embodiment of the present disclosure further provides a text detection method comprising:
S51, obtaining data to be detected, wherein the data to be detected can be any image data containing a character.
S52, inputting the data to be detected into a pre-trained deep learning model, to obtain a single character segmentation prediction result and a text line segmentation prediction result of the data to be detected.

In this embodiment, one can refer to the method of training a deep learning model for text detection in the above-described embodiments regarding the process of training the deep learning model, and refer to the structure of the deep learning model in the above-described embodiments regarding the structure of the deep learning model, which are not described again.

In a possible implementation, the deep learning model is a deep learning model with the first character number prediction sub-network and the second character number prediction sub-network being removed. During a text detection stage, on the basis of the structure of the deep learning model in the above-described embodiments, the first character number prediction sub-network and the second character number prediction sub-network in the deep learning model can be removed, thus reducing data amount of the deep learning model and allowing saving of resources of operating the first character number prediction sub-network and the second character number prediction sub-network.

S53, determining a text area in the data to be detected based on the single character segmentation prediction result and the text line segmentation prediction result of the data to be detected.

Based on the single character segmentation prediction result and the text line segmentation prediction result, an OR operation is performed on the text area, and then the outer contour of its connected area is taken as the contour of the finally detected text area.

In an embodiment of the present disclosure, text detection is achieved by using a deep learning model to realize simultaneous predictions with single character segmentation and text line segmentation. Text area detection accuracy can be increased by combining two ways of text segmentation for text area.

In a possible implementation, with reference to FIG. 6, determining the text area in the data to be detected based on the single character segmentation prediction result and the text line segmentation prediction result of the data to be detected, comprises:
S61, labeling an area predicted to have a character in the data to be detected as a first value and labeling an area without a character as second data, based on the single character segmentation prediction result of the data to be detected, to obtain a first binary map;
S62, labeling an area predicted to have a character in the data to be detected as a first value and labeling an area without a character as second data, based on the text line segmentation prediction result of the data to be detected, to obtain a second binary map;
S63, taking a union of an area with the first value in the first binary map and an area with the first value in the second binary map, to obtain a text area in the data to be detected.

Union is taken of the area with the first value in the first binary map and the area with the first value in the second binary map, and the outer contour of the unified connected area is the contour of the finally detected text area.

In an embodiment of the present disclosure, text detection is achieved by means of a binary map, which can accurately and effectively realize the combination of single character segmentation and text line segmentation, increase text area detection efficiency, and increase text detection area accuracy.

An embodiment of the present disclosure further provides an apparatus of training a deep learning model for text detection. With reference to FIG. 7, the apparatus comprises: a deep learning model obtaining module 701 configured for obtaining a deep learning model to be trained, wherein, the deep learning model comprises a single character prediction network and a text line prediction network, the single character prediction network comprises a single character segmentation sub-network and a first character number prediction sub-network, the text line prediction network comprises a text line segmentation sub-network and a second character number prediction sub-network; a first-type sample data selecting module 702 configured for selecting a piece of first-type sample data and tag data of the currently selected first-type sample data; a prediction result determining module 703 configured for inputting the currently selected first-type sample data into the deep learning model, to obtain a prediction result of the currently selected first-type sample data, wherein, the prediction result comprises a single character segmentation prediction result, a first character number prediction value, a text line segmentation prediction result, and a second character number prediction value; a training parameter adjusting module 704 configured for adjusting training parameters of the deep learning model based on the prediction result and the tag data of the currently selected first-type sample data, to obtain a trained deep learning model.

In a possible implementation, the deep learning model further comprises an encoder network, a first decoder network, and a second decoder network; the prediction result determining module comprises a global feature extraction sub-module configured for performing feature extraction on the currently selected first-type sample data using the encoder network, to obtain a global feature; a first high-level feature extraction sub-module configured for performing feature extraction on the global feature using the first decoder network, to obtain a first high-level feature; a second high-level feature extraction sub-module configured for performing feature extraction on the global feature using the second decoder network, to obtain a second high-level feature; a first prediction sub-module configured for processing the first high-level feature using the single character segmentation sub-network, to obtain an outputted single character segmentation prediction result, and processing the first high-level feature using the first character number prediction sub-network, to obtain a first character number prediction value; a second prediction sub-module configured for processing the second high-level feature using the text line segmentation sub-network, to obtain a text line segmentation prediction result, and processing the second high-level feature using the second character number prediction sub-network, to obtain the second character number prediction value.

In a possible implementation, the tag data of the first-type sample data comprises at least one of a character number true value, a single character segmentation true value result, and a text line segmentation true value result; the training parameter adjusting module is configured for executing at least one of: calculating a first loss based on the single character segmentation prediction result of the currently selected first-type sample data and the single character segmentation true value result of the currently selected first-type sample data; adjusting training parameters of at least one of the encoder network, the first decoder network, and the single character segmentation sub-network based on the first loss; calculating a second loss based on the first character number prediction value of the currently selected first-type sample data and the character number true value of the currently selected first-type sample data; adjusting training parameters of at least one of the encoder network, the first decoder network, and the first character number prediction sub-network based on the second loss; calculating a third loss based on the text line segmentation prediction result of the currently selected first-type sample data and the text line segmentation true value result of the currently selected first-type sample data; adjusting training parameters of at least one of the encoder network, the second decoder network, and the text line segmentation sub-network based on the third loss; calculating a fourth loss based on the second character number prediction value of the currently selected first-type sample data and the character number true value of the currently selected first-type sample data; adjusting training parameters of at least one of the encoder network, the second decoder network, and the second character number prediction sub-network based on the fourth loss.

In a possible implementation, the apparatus further comprises a mutual learning module configured for: determining relative entropies of the first character number prediction values and the second character number prediction values of multiple pieces of first-type sample data based on the first character number prediction values and the second character number prediction values, to obtain first relative entropies; adjusting training parameters of at least one of the first character number prediction sub-network and the second character number prediction sub-network based on the first relative entropies.

In a possible implementation, the deep learning model training module is specifically configured for: continuing to select first-type sample data to perform supervised training on the deep learning model, and performing unsupervised training on the deep learning model using second-type sample data, until a preset training completion condition is satisfied, so that the trained deep learning model is obtained.

In a possible implementation, the deep learning model training module is specifically configured for: obtaining multiple pieces of second-type sample data; performing data augmentation on the respective pieces of second-type sample data, to obtain respective pieces of third-type sample data corresponding to the respective pieces of second-type sample data; inputting the respective pieces of second-type sample data into the trained deep learning model, to obtain third character number prediction values of the respective pieces of second-type sample data outputted by the first character number prediction sub-network; inputting the respective pieces of third-type sample data into the trained deep learning model, to obtain fourth character number prediction values of the respective pieces of third-type sample data outputted by the second character number prediction sub-network; determining relative entropies of the third character number prediction values of the respective pieces of second-type sample data and the fourth character number prediction values of the respective pieces of third-type sample data based on the third character number prediction values and the fourth character number prediction values, to obtain second relative entropies; adjusting training parameters of at least one of the first character number prediction sub-network and the second character number prediction sub-network according to the second relative entropies.

An embodiment of the present disclosure further provides a text detection apparatus comprising: a to-be-detected data obtaining module configured for obtaining data to be detected; a prediction result determining module configured for inputting the data to be detected into a pre-trained deep learning model, to obtain a single character segmentation prediction result and a text line segmentation prediction result of the data to be detected, wherein, the deep learning model is obtained based on the apparatus of training a deep learning model for text detection described in the present application; a text area determining module configured for determining a text area in the data to be detected based on the single character segmentation prediction result and the text line segmentation prediction result of the data to be detected.

In a possible implementation, the text area determining module is specifically configured for: labeling an area predicted to have a character in the data to be detected as a first value and labeling an area without a character as second data, based on the single character segmentation prediction result of the data to be detected, to obtain a first binary map; labeling an area predicted to have a character in the data to be detected as a first value and labeling an area without a character as second data, based on the text line segmentation prediction result of the data to be detected, to obtain a second binary map; taking a union of an area of the first value in the first binary map and an area of the first value in the second binary map, to obtain the text area in the data to be detected.

In a possible implementation, the deep learning model is a deep learning model with the first character number prediction sub-network and the second character number prediction sub-network being removed.

In the technical solutions of the present disclosure, the obtaining, storage, and use of a user's personal information involved comply with the requirements of relevant laws and regulations and do not violate public order or moral standards.

According to an embodiment of the present disclosure, the present disclosure further provides an electronic device, a readable storage medium, and a computer program product.

An electronic device comprises: at least one processor; and, a memory communicatively coupled with the at least one processor; wherein, the memory has stored thereon instructions capable of being executed by the at least one processor, the instructions are executed by the at least processor to enable the at least one processor to execute the method any method of training a deep learning model for text detection or text detection method described in the present application.

A non-transitory computer-readable storage medium having stored thereon computer instructions which are configured to enable the computer to execute any method of training a deep learning model for text detection or text detection method described in the present application.

A computer program product is provided, including a computer program, wherein the computer program, when executed by a processor, causes the processor to execute any method of training a deep learning model for text detection or text detection method described in the present application.

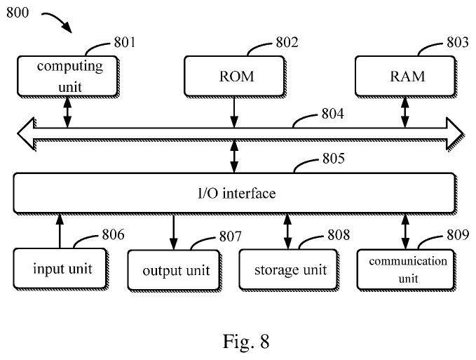

FIG. 8 shows a schematic block diagram of an example electronic device 800 that may be used to implement embodiments of the present disclosure. Electronic device is intended to represent various forms of digital computers, such as laptops, desktops, workstations, personal digital assistants, servers, blade servers, mainframes, and other suitable computers. Electronic device may also represent various forms of mobile devices, such as personal digital processing, cellular telephones, smart phones, wearable devices, and other similar computing devices. The components shown herein, their connections and relationships, and their functions, are by way of example only, and are not intended to limit implementations of the disclosure described and/or claimed herein.

As shown in FIG. 8, the device 800 comprises a computing unit 801 that can execute various appropriate actions and treatments according to a computer program stored in a read-only memory (ROM) 802 or loaded from a storage unit 808 into a random-access memory (RAM) 803. In the RAM 803, various programs and data necessary for the operation of the device 800 can also be stored. The computing unit 801, ROM 802, and RAM 803 are connected to each other through a bus 804. An input/output (I/O) interface 805 is also connected to bus 804.

Multiple components in the device 800 are connected to the I/O interface 805, including: an input unit 806, such as a keyboard, a mouse, and the like; an output unit 807, such as various types of displays, speakers, or the like; a storage unit 808, such as a magnetic disk, an optical disk, and the like; and a communication unit 809, such as a network card, a modem, a wireless communication transceiver, and the like. The communication unit 809 allows the device 800 to exchange information/data with other devices over a computer network such as the Internet and/or various telecommunication networks.

The computing unit 801 may be various general-purpose and/or special-purpose processing components having processing and computing capabilities. Some examples of computing units 801 include, but are not limited to, central processing units (CPUs), graphics processing units (GPUs), various dedicated artificial intelligence (AI) computing chips, various computing units that run machine learning model algorithms, digital signal processing processor (DSP), and any suitable processor, controller, micro-controller, and the like. The computing unit 801 executes various methods and processes described above. For example, in some embodiments, the methods of the present disclosure may be implemented as a computer software program tangibly embodied in a machine-readable medium, such as the storage unit 808. In some embodiments, part or all of the computer program may be loaded and/or installed onto the device 800 via the ROM 802 and/or the communication unit 809. When the computer program is loaded into the RAM 803 and executed by the computing unit 801, one or more steps of the cloud code developing methods described above can be performed. Alternatively, in other embodiments, the computing unit 801 may be configured in any other appropriate way (for example, by means of firmware) to execute the methods of the present disclosure.

Various implementations of the systems and techniques described above herein can be implemented in digital electronic circuit systems, integrated circuit systems, field programmable gate arrays (FPGAs), application specific integrated circuits (ASICs), application specific standard products (ASSPs), system-on-chip System (SOC), Complex Programmable Logic Device (CPLD), computer hardware, firmware, software, and/or combinations thereof. These various embodiments may include being implemented in one or more computer programs executable and/or interpreted on a programmable system including at least one programmable processor, the programmable processor can be special-purpose or general-purpose programmable processor, can receive data and instruction from storage system, at least one input device, and at least one output device, and transmit data and instruction to the storage system, the at least one input device, and the at least one output device.

Program codes for implementing the methods of the present disclosure may be written in any combination of one or more programming languages. These program codes can be provided to a processor or controller of a general-purpose computer, a special-purpose computer, or other programmable data processing devices, so that the program codes, when executed by the processor or controller, cause the functions/operations specified in the flow diagrams and/or block diagrams to be implemented. The program code may execute entirely on the machine, partly on the machine, as a stand-alone software package partly on the machine and partly on a remote machine or entirely on the remote machine or server.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or device, or any suitable combination of the foregoing. More specific examples of machine-readable storage medium would include one or more wire-based electrical connections, portable computer disks, hard disks, Random Access Memory (RAM), Read Only Memory (ROM), Erasable Programmable Read Only Memory (EPROM or flash memory), fiber optics, compact disk read-only memory (CD-ROM), optical storage devices, magnetic storage devices, or any suitable combination of the foregoing.

To provide for interaction with the user, the systems and techniques described herein can be implemented on a computer having a display device (e.g., a CRT (cathode ray tube) or LCD (liquid crystal display) monitor) for displaying information to the user; and a keyboard and pointing device (eg, a mouse or a trackball) through which the user can provide input to the computer. Other kinds of devices may also be used to provide interaction with the user; for example, the feedback provided to the user may be any form of sensory feedback (e.g., visual feedback, auditory feedback, or tactile feedback); and may be in any form (including acoustic input, voice input, or tactile input) to receive input from the user.

The systems and techniques described herein can be implemented on a computing system that includes back-end components (e.g., as a data server), or a computing system that includes middleware components (e.g., an application server), or a computing system that includes front-end components (e.g., a user computer having a graphical user interface or web browser through which a user can interact with implementation of the systems and techniques described herein), or any combination including such back-end components, middleware components, front-end components in a computing system. The components of the system can be interconnected by any form or medium of digital data communication (eg, a communication network). Examples of communication networks include: Local Area Networks (LANs), Wide Area Networks (WANs), and the Internet.

A computer system may include a client and a server. The Client and server are generally remote from each other and typically interact through a communication network. The relationship of client and server arises by computer programs running on the respective computers and having a client-server relationship to each other. The server can be a cloud server, a server of a distributed system, or a server combined with a block chain.

It should be understood that steps may be reordered, added or deleted using the various forms of flow shown above. For example, each step described in the present disclosure may be executed in parallel, sequentially, or in a different order, as long as the desired result of the technical solution disclosed in the present disclosure can be achieved, which is not limited herein.

The specific modes of implementation described above do not limit the protection scope of the present disclosure. It should be apparent to those skilled in the art that various modifications, combinations, sub-combinations and substitutions may be made depending on design requirements and other factors. Any modifications, equivalent replacements and improvements made within the spirit and principles of the present disclosure shall fall within the protection scope of the present disclosure.

What is claimed is:

1. A method of training a deep learning model for text detection, wherein the method comprises:
obtaining a deep learning model to be trained, wherein, the deep learning model comprises a single character prediction network and a text line prediction network, the single character prediction network comprises a single character segmentation sub-network and a first character number prediction sub-network, the text line prediction network comprises a text line segmentation sub-network and a second character number prediction sub-network;
selecting a piece of first-type sample data and tag data of the currently selected first-type sample data;
inputting the currently selected first-type sample data into the deep learning model, to obtain a prediction result of the currently selected first-type sample data, wherein, the prediction result comprises a single character segmentation prediction result, a first character number prediction value, a text line segmentation prediction result, and a second character number prediction value;
adjusting training parameters of the deep learning model based on the prediction result and the tag data of the currently selected first-type sample data, to obtain a trained deep learning model.

2. The method according to claim 1, wherein, the deep learning model further comprises an encoder network, a first decoder network, and a second decoder network;
inputting the currently selected first-type sample data into the deep learning model, to obtain the prediction result of the currently selected first-type sample data, comprises:
performing feature extraction on the currently selected first-type sample data using the encoder network, to obtain a global feature;
performing feature extraction on the global feature using the first decoder network, to obtain a first high-level feature;
performing feature extraction on the global feature using the second decoder network, to obtain a second high-level feature;
processing the first high-level feature using the single character segmentation sub-network, to obtain an outputted single character segmentation prediction result, and processing the first high-level feature using the first character number prediction sub-network, to obtain a first character number prediction value;
processing the second high-level feature using the text line segmentation sub-network, to obtain a text line segmentation prediction result, and processing the second high-level feature using the second character number prediction sub-network, to obtain the second character number prediction value.

3. The method according to claim 2, wherein, the tag data of the first-type sample data comprises at least one of a character number true value, a single character segmentation true value result, and a text line segmentation true value result;
adjusting the training parameters of the deep learning model based on the prediction result and the tag data of the currently selected first-type sample data comprises at least one of:
calculating a first loss based on the single character segmentation prediction result of the currently selected first-type sample data and the single character segmentation true value result of the currently selected first-type sample data; adjusting training parameters of at least one of the encoder network, the first decoder network, and the single character segmentation sub-network based on the first loss;
calculating a second loss based on the first character number prediction value of the currently selected first-type sample data and the character number true value of the currently selected first-type sample data; adjusting training parameters of at least one of the encoder network, the first decoder network, and the first character number prediction sub-network based on the second loss;
calculating a third loss based on the text line segmentation prediction result of the currently selected first-type sample data and the text line segmentation true value result of the currently selected first-type sample data; adjusting training parameters of at least one of the encoder network, the second decoder network, and the text line segmentation sub-network based on the third loss;
calculating a fourth loss based on the second character number prediction value of the currently selected first-type sample data and the character number true value of the currently selected first-type sample data; adjusting training parameters of at least one of the encoder network, the second decoder network, and the second character number prediction sub-network based on the fourth loss.

4. The method according to claim 1, wherein the method further comprises:
determining relative entropies of first character number prediction values and second character number prediction values of multiple pieces of first-type sample data based on the first character number prediction values and the second character number prediction values, to obtain first relative entropies;
adjusting training parameters of at least one of the first character number prediction sub-network and the second character number prediction sub-network based on the first relative entropies.

5. The method according to claim 1, wherein, the obtaining of the trained deep learning model comprises:
continuing to select first-type sample data to perform supervised training on the deep learning model, and performing unsupervised training on the deep learning model using second-type sample data, until a preset training completion condition is satisfied, so that the trained deep learning model is obtained.

6. The method according to claim 5, wherein, performing the unsupervised training on the deep learning model using the second-type sample data comprises:
obtaining multiple pieces of second-type sample data;
performing data augmentation on the respective pieces of second-type sample data, to obtain respective pieces of third-type sample data corresponding to the respective pieces of second-type sample data;
inputting the respective pieces of second-type sample data into the trained deep learning model, to obtain third character number prediction values of the respective pieces of second-type sample data outputted by the first character number prediction sub-network;
inputting the respective pieces of third-type sample data into the trained deep learning model, to obtain fourth character number prediction values of the respective pieces of third-type sample data outputted by the second character number prediction sub-network;
determining relative entropies of the third character number prediction values of the respective pieces of second-type sample data and the fourth character number prediction values of the respective pieces of third-type sample data based on the third character number prediction values and the fourth character number prediction values, to obtain second relative entropies;
adjusting training parameters of at least one of the first character number prediction sub-network and the second character number prediction sub-network according to the second relative entropies.

7. A text detection method, comprising:
obtaining data to be detected;
inputting the data to be detected into a pre-trained deep learning model, to obtain a single character segmentation prediction result and a text line segmentation prediction result of the data to be detected, wherein, the deep learning model is obtained based on the method of training a deep learning model for text detection according to claim 1;
determining a text area in the data to be detected based on the single character segmentation prediction result and the text line segmentation prediction result of the data to be detected.

8. The method according to claim 7, wherein, determining the text area in the data to be detected based on the single character segmentation prediction result and the text line segmentation prediction result of the data to be detected, comprises:
labeling an area predicted to have a character in the data to be detected as a first value and labeling an area without a character as second data, based on the single character segmentation prediction result of the data to be detected, to obtain a first binary map;
labeling an area predicted to have a character in the data to be detected as a first value and labeling an area without a character as second data, based on the text line segmentation prediction result of the data to be detected, to obtain a second binary map;
taking a union of an area of the first value in the first binary map and an area of the first value in the second binary map, to obtain the text area in the data to be detected.

9. The method according to claim 7, wherein, the deep learning model is a deep learning model with the first character number prediction sub-network and the second character number prediction sub-network being removed.

10. An apparatus of training a deep learning model for text detection, wherein the apparatus comprises:
a deep learning model obtaining module configured for obtaining a deep learning model to be trained, wherein, the deep learning model comprises a single character prediction network and a text line prediction network, the single character prediction network comprises a single character segmentation sub-network and a first character number prediction sub-network, the text line prediction network comprises a text line segmentation sub-network and a second character number prediction sub-network;
a first-type sample data selecting module configured for selecting a piece of first-type sample data and tag data of the currently selected first-type sample data;
a prediction result determining module configured for inputting the currently selected first-type sample data into the deep learning model, to obtain a prediction result of the currently selected first-type sample data, wherein, the prediction result comprises a single character segmentation prediction result, a first character number prediction value, a text line segmentation prediction result, and a second character number prediction value;
a training parameter adjusting module configured for adjusting training parameters of the deep learning model based on the prediction result and the tag data of the currently selected first-type sample data, to obtain a trained deep learning model.

11. The apparatus according to claim 10, wherein, the deep learning model further comprises an encoder network, a first decoder network, and a second decoder network;
the prediction result determining module comprises:
a global feature extraction sub-module configured for performing feature extraction on the currently selected first-type sample data using the encoder network, to obtain a global feature;
a first high-level feature extraction sub-module configured for performing feature extraction on the global feature using the first decoder network, to obtain a first high-level feature;
a second high-level feature extraction sub-module configured for performing feature extraction on the global feature using the second decoder network, to obtain a second high-level feature;
a first prediction sub-module configured for processing the first high-level feature using the single character segmentation sub-network, to obtain an outputted single character segmentation prediction result, and processing the first high-level feature using the first character number prediction sub-network, to obtain a first character number prediction value;
a second prediction sub-module configured for processing the second high-level feature using the text line segmentation sub-network, to obtain a text line segmentation prediction result, and processing the second high-level feature using the second character number prediction sub-network, to obtain the second character number prediction value.

12. The apparatus according to claim 11, wherein, the tag data of the first-type sample data comprises at least one of a character number true value, a single character segmentation true value result, and a text line segmentation true value result;
the training parameter adjusting module is configured for executing at least one of:
calculating a first loss based on the single character segmentation prediction result of the currently selected first-type sample data and the single character segmentation true value result of the currently selected first-type sample data; adjusting training parameters of at least one of the encoder network, the first decoder network, and the single character segmentation sub-network based on the first loss;
calculating a second loss based on the first character number prediction value of the currently selected first-type sample data and the character number true value of the currently selected first-type sample data; adjusting training parameters of at least one of the encoder network, the first decoder network, and the first character number prediction sub-network based on the second loss;
calculating a third loss based on the text line segmentation prediction result of the currently selected first-type sample data and the text line segmentation true value result of the currently selected first-type sample data; adjusting training parameters of at least one of the encoder network, the second decoder network, and the text line segmentation sub-network based on the third loss;
calculating a fourth loss based on the second character number prediction value of the currently selected first-type sample data and the character number true value of the currently selected first-type sample data; adjusting training parameters of at least one of the encoder network, the second decoder network, and the second character number prediction sub-network based on the fourth loss.

13. The apparatus according to claim 10, wherein, the apparatus further comprises a mutual learning module configured for: determining relative entropies of first character number prediction values and second character number prediction values of multiple pieces of first-type sample data based on the first character number prediction values and the second character number prediction values, to obtain first relative entropies; adjusting training parameters of at least one of the first character number prediction sub-network and the second character number prediction sub-network based on the first relative entropies.

14. The apparatus according to claim 10, wherein the deep learning model training module is specifically configured for: continuing to select first-type sample data to perform supervised training on the deep learning model, and performing unsupervised training on the deep learning model using second-type sample data, until a preset training completion condition is satisfied, so that the trained deep learning model is obtained.

15. The apparatus according to claim 14, the deep learning model training module is specifically configured for: obtaining multiple pieces of second-type sample data; performing data augmentation on the respective pieces of second-type sample data, to obtain respective pieces of third-type sample data corresponding to the respective pieces of second-type sample data; inputting the respective pieces of second-type sample data into the trained deep learning model, to obtain third character number prediction values of the respective pieces of second-type sample data outputted by the first character number prediction sub-network; inputting the respective pieces of third-type sample data into the trained deep learning model, to obtain fourth character number prediction values of the respective pieces of third-type sample data outputted by the second character number prediction sub-network; determining relative entropies of the third character number prediction values of the respective pieces of second-type sample data and the fourth character number prediction values of the respective pieces of third-type sample data based on the third character number prediction values and the fourth character number prediction values, to obtain second relative entropies; adjusting training parameters of at least one of the first character number prediction sub-network and the second character number prediction sub-network according to the second relative entropies.

16. A text detection apparatus comprising:
a to-be-detected data obtaining module configured for obtaining data to be detected;
a prediction result determining module configured for inputting the data to be detected into a pre-trained deep learning model, to obtain a single character segmentation prediction result and a text line segmentation prediction result of the data to be detected, wherein, the deep learning model is obtained based on the apparatus of training a deep learning model for text detection according to claim 10;
a text area determining module configured for determining a text area in the data to be detected based on the single character segmentation prediction result and the text line segmentation prediction result of the data to be detected.

17. The apparatus according to claim 16, wherein the text area determining module is specifically configured for: labeling an area predicted to have a character in the data to be detected as a first value and labeling an area without a character as second data, based on the single character segmentation prediction result of the data to be detected, to obtain a first binary map; labeling an area predicted to have a character in the data to be detected as a first value and labeling an area without a character as second data, based on the text line segmentation prediction result of the data to be detected, to obtain a second binary map; taking a union of an area of the first value in the first binary map and an area of the first value in the second binary map, to obtain the text area in the data to be detected.

18. An electronic device, comprising:
at least one processor; and,
a memory communicatively coupled with the at least one processor; wherein,
the memory has stored thereon instructions capable of being executed by the at least one processor, wherein the instructions are executed by the at least processor to enable the at least one processor to execute the method according to claim 1.

19. A non-transitory computer-readable storage medium having stored thereon computer instructions which are configured to enable the computer to execute the method according to claim 1.

20. (canceled)
